(19) United States
(12) Patent Application Publication
(10) Pub. No.: US 2025/0167418 A1
(43) Pub. Date: May 22, 2025

(54) Millimeter waveguide and transmission system comprising such a waveguide

(71) Applicant: Commissariat à l'Energie Atomique et aux Energies Alternatives, PARIS (FR)

(72) Inventor: José Luis GONZALEZ JIMENEZ, GRENOBLE (FR)

(21) Appl. No.: 18/942,577

(22) Filed: Nov. 9, 2024

(30) Foreign Application Priority Data
Nov. 17, 2023 (FR) 2312646

(51) Int. Cl. H01P 3/16; H01P 5/02

(52) U.S. Cl. CPC H01P 3/16; H01P 5/02

(57) ABSTRACT

The present description concerns a millimeter waveguide (50) comprising a first part (51) coupled to a second part (52), the first part (51) comprising first waveguides (54₁, 54₂, 54₃) each being configured to receive a first millimeter wave, and the second part corresponding to a second waveguide, each first waveguide (54₁, 54₂, 54₃) comprising a first free end (55₁, 55₂, 55₃) and a second end joined with the second waveguide (52), each first and second waveguide being made of a dielectric material.

### FIELD

The present application concerns a millimeter waveguide made of a dielectric material and a millimeter wave transmission system comprising such a waveguide.

### BACKGROUND

It is known to transmit millimeter waves via a waveguide made of dielectric plastic material. For certain applications, it is desirable to be able to transmit millimeter waves corresponding to the aggregation of a plurality of millimeter waves in different frequency bands, each corresponding to a signal to be transmitted.

FIG. 1 is a diagram showing an example of a millimeter wave transmission system 5. Millimeter wave transmission system 5 comprises a millimeter wave transmission device 10, a millimeter wave reception device 30, and a waveguide 20 made of dielectric plastic material transmitting millimeter electromagnetic waves between transmission device 10 and reception device 30.

Millimeter wave transmission device 10 comprises N transmission blocks 11₁ to 11_{N}, N being an integer in the range from 2 and 8 typically, but that may be a higher integer, N being equal to 3 as an example in FIG. 1. Each transmission block 11ᵢ, i varying from 1 to N, comprises a modulation circuit 12; receiving at least one digital signal SBTᵢ and delivering an analog signal STᵢ in a frequency band that may depend on block 11ⱼ. Transmission device 10 further comprises a combination circuit 14 receiving the analog signals ST₁ to ST_{N} delivered by transmission blocks 11₁ to 11_{N} and delivering a global analog signal STG in a transmission frequency band ΔB substantially corresponding to the sum of the signals ST₁ to ST_{N} to drive a millimeter electromagnetic wave transmission antenna 15. Combination circuit 14 may be formed by conductive tracks of a printed circuit board. The electromagnetic millimeter waves delivered by antenna 15 are guided by waveguide 20 to reception device 30.

Millimeter wave reception device 30 comprises a millimeter wave reception antenna 31 capturing the millimeter electromagnetic waves delivered by waveguide 20 and delivering a reception signal SRG in transmission band ΔB. Reception device 30 further comprises a distribution circuit 32 receiving analog reception signal SRG and delivering M analog receive signals SR₁ to SR_{M} to M receive blocks 33₁ to 33_{M}, M being an integer between 1 and 8 typically, but that may be a higher integer, M being equal to 3 as an example in FIG. 1. Each reception block 33ⱼ, j varying from 1 to M, comprises a demodulation circuit 34ⱼ receiving reception signal SRⱼ and delivering a signal SBRⱼ in the final frequency band.

A disadvantage of the millimeter wave transmission system 5 of FIG. 1 is that the generation of global analog signal STG may exhibit significant losses. A disadvantage of the millimeter wave transmission system 5 of FIG. 1 is that a good coupling between waveguide 20 and each antenna 31 and 35 may be difficult to achieve over the entire transmission frequency band ΔB, which may be larger than several tens of GHz.

### SUMMARY

Δn embodiment overcomes all or part of the disadvantages of known millimeter waveguides made of a dielectric material and of millimeter wave transmission systems comprising such a waveguide.

An embodiment provides a millimeter waveguide comprising a first part coupled to a second part, the first part comprising first waveguides, each configured to receive a first millimeter wave, and the second part corresponding to a second waveguide, each first waveguide comprising a first free end and a second end joined with the second waveguide, each first and second waveguide being entirely made of a dielectric material.

According to an embodiment, the millimeter waveguide further comprises a third portion comprising third waveguides, each third waveguide comprising a first free end and a second end joined with the second waveguide.

According to an embodiment, the first and second waveguides each comprise a tube delimiting an inner volume filled with a gas, with a gas mixture, with a fluid, or with a solid having a dielectric constant lower than that of the dielectric material.

According to an embodiment, the dimensions of the cross-sections of the first waveguides are different.

According to an embodiment, the cross-section of the tube of at least one of the first waveguides is rectangular, and the cross-section of the tube of the second waveguide is circular.

According to an embodiment, the first and second waveguides are each made of a plastic material, in particular polytetrafluoroethylene, polypropylene, or polystyrene.

An embodiment also provides a system for transmitting first millimeter waves comprising a millimeter waveguide such as previously defined, a millimeter wave transmission device, and a millimeter wave reception device, the millimeter wave transmission device comprising, for each first waveguide, an antenna configured for the transmission of millimeter waves and coupled with said first waveguide.

According to an embodiment, each first millimeter wave has a frequency band in the range from 30 GHz to 300 GHz.

According to an embodiment, the frequency bands of the first millimeter waves are distinct.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1, previously described, is a diagram showing an example of a millimeter wave transmission system;

FIG. 2 is a diagram showing an embodiment of a millimeter wave transmission system;

FIG. 3 is a diagram showing another embodiment of a millimeter wave transmission system;

FIG. 4 is a cross-section view, partial and simplified, of an embodiment of a branch of a waveguide of the millimeter wave transmission system of FIG. 2;

FIG. 5 is a perspective view, partial and simplified, of an embodiment of the waveguide of the millimeter wave transmission system of FIG. 2;

FIG. 6 is a perspective view, partial and simplified, of another embodiment of the waveguide of the millimeter wave transmission system of FIG. 2;

FIG. 7 and FIG. 8 respectively are a top view and a side view, partial and simplified, of an embodiment of assembly between the waveguide and a transmission device of the millimeter wave transmission system of FIG. 2;

FIG. 9 and FIG. 10 respectively are a top view and a side view, partial and simplified, of another embodiment of assembly between the waveguide and the transmission device of the millimeter wave transmission system of FIG. 2;

FIG. 11 is a block diagram of an embodiment of a transmission block of the millimeter wave transmission system of FIG. 2;

FIG. 12 is a block diagram of an alternative implementation of the transmission block of the millimeter wave transmission system shown in FIG. 2; and

FIG. 13 is a perspective view, partial and simplified, of the inner volume of a waveguide of the millimeter wave transmission system of FIG. 2, incorporating a filtering function.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, millimeter wave transmission and reception circuits are well known to those skilled in the art and are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%. In the rest of the disclosure, there is called millimeter wave an electromagnetic wave having a wavelength that can vary between 1 mm and 10 mm, which corresponds to a frequency that can vary between 30 GHz and 300 GHz.

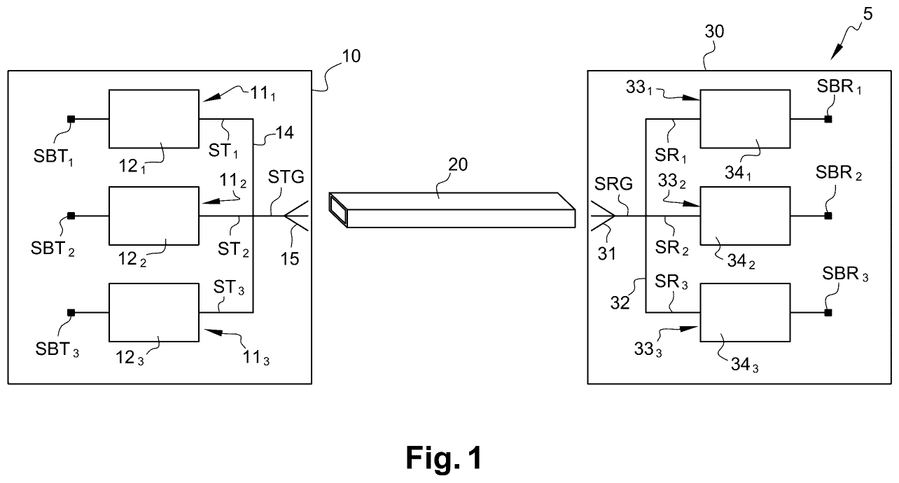

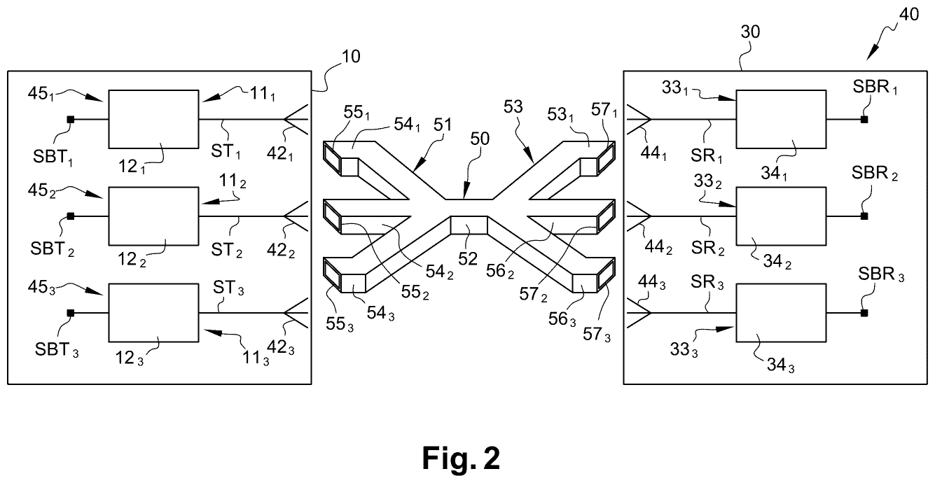

FIG. 2 is a diagram showing an embodiment of a millimeter wave transmission system 40. Millimeter wave transmission system 40 comprises all the elements of the millimeter wave transmission system 5 shown in FIG. 1, with the difference that combination circuit 14, antenna 15, antenna 31, and distribution circuit 32 are not present, that transmission device 10 comprises an antenna 42ᵢ for each transmission block 11ᵢ, i varying from 1 to N, that reception device 30 comprises an antenna 44ⱼ for each reception block 33ⱼ, j varying from 1 to M, and that waveguide 20 is replaced by a waveguide 50. Each transmission block 11ᵢ, i varying from 1 to N, and the corresponding antenna 42ᵢ then form a circuit 45ᵢ for transmitting millimeter waves in a transmission frequency band ΔBᵢ.

According to an embodiment, waveguide 50 comprises a first part, also called collection part 51, a second part 52, and a third part, also called distribution part 53. Central waveguide 52 couples collection part 51 to distribution part 53.

Collection part 51 comprises N branches 54₁ to 54_{N} (three branches 54₁, 54₂, and 54₃ being shown as an example in FIG. 2). Each branch 54ᵢ, i varying from 1 to N, corresponds to a first waveguide. The second part 52 corresponds to a second waveguide, called central waveguide hereafter. Each branch 54ᵢ, i varying from 1 to N, comprises a free end 55; and is connected, on the side opposite to free end 55ᵢ, to central waveguide 52. Distribution part 53 comprises M branches 56₁ to 56_{M} (three branches 56₁, 56₂, and 56₃ being shown in FIG. 2). According to the envisaged application, number M may be equal to N or different from N. Each branch 56ⱼ, j varying from 1 to M, corresponds to a third waveguide which comprises a free end 57ⱼ and which is connected, on the side opposite to free end 57ⱼ, to central waveguide 52.

According to an embodiment, waveguide 50 is entirely made of a dielectric material. In particular, waveguide 50 comprises no electrically-conductive elements, in particular metal elements. This advantageously enables to form a flexible waveguide 50, in particular exhibiting elastic deformations.

Each antenna 42ᵢ, i varying from 1 to N, is located close to, preferably in contact with, the axial end 55ᵢ of branch 54ᵢ. Each antenna 42ᵢ is for example adapted to transmitting millimeter waves which propagate in the corresponding branch 54ᵢ. Each antenna 42ᵢ is adapted to transmitting a millimeter wave in transmission frequency band ΔBᵢ. By coupling between antenna 42ᵢ and the corresponding branch 54ᵢ, the millimeter wave in transmission frequency band ΔBᵢ propagates through branch 54ᵢ all the way to central waveguide 52. The millimeter waves add up at the junction between each branch 54ᵢ and central waveguide 52 to form a millimeter wave in transmission frequency band ΔB. Each antenna 44ⱼ, j varying from 1 to M, is arranged close to, preferably in contact with, the axial end 57ⱼ of branch 56ⱼ. Each antenna 44ⱼ is for example adapted to capturing millimeter waves which propagate in the corresponding branch 56ⱼ.

For the system 40 of FIG. 2, the aggregation of millimeter waves in transmission frequency bands ΔBᵢ is performed by waveguide 50, while for the system 5 of FIG. 2, this aggregation is performed on signals STᵢ by the combiner circuit 14 of transmission device 10. The aggregation of millimeter waves in transmission frequency bands ΔBᵢ may advantageously be carried out with fewer losses, in particular insertion losses, by waveguide 50 than when it is carried out by combiner circuit 14. Similarly, for the system 40 of FIG. 2, the distribution of millimeter waves in transmission frequency bands ΔBᵢ is performed by waveguide 50, whereas for the system 5 of FIG. 2, this distribution is performed on signals STᵢ by the distribution circuit 32 of reception device 30. The distribution of millimeter waves in transmission frequency bands ΔBᵢ may, advantageously, be carried out with fewer losses, in particular insertion losses, by waveguide 50 than when it is carried out by distribution circuit 32.

According to an application, signals STᵢ, i varying from 1 to N, correspond to different signals. Transmission frequency bands ΔBᵢ may then be distinct, and transmission frequency band ΔB may correspond to the sum of transmission frequency bands ΔBᵢ. The width of transmission frequency band ΔB is then greater than the width of each transmission frequency band ΔBᵢ. According to an embodiment, the width of each transmission frequency band ΔBᵢ may be smaller than 10 GHz. As an example, transmission device 10 may deliver signals ST₁, ST₂, ST₃, and ST₄, signal ST₁ being in the frequency band ΔB₁ from 122 GHz to 131 GHZ, signal ST₂ being in the frequency band ΔB₂ from 131 GHz to 140 GHz, signal ST₃ being in the frequency band ΔB₃ from 140 GHz to 149 GHz, and signal ST₄ being in the frequency band ΔB₄ from 149 GHz to 157 GHz. The width of each frequency band ΔB₁, ΔB₂, ΔB₃, and ΔB₄ is equal to 9 GHz. The millimeter waves conveyed in central waveguide 52 then are in the frequency band ΔB from 122 GHz to 157 GHz. The width of frequency band ΔB is equal to 35 GHz. The efficiency of the coupling between a millimeter waveguide and an antenna depends in particular on the width of the millimeter-wave frequency band to be transmitted to the waveguide. Thereby, the coupling between each antenna 42ᵢ and branch 54ᵢ for the system 40 of FIG. 2, which is to be formed over frequency band ΔBᵢ, may advantageously be more efficient than the coupling between antenna 15 and waveguide 20 for the system 5 of FIG. 2, which is to be formed over the wider frequency band ΔB.

According to an application, signals STᵢ are identical. Transmission frequency bands ΔBᵢ may then be substantially identical and transmission frequency band ΔB may be substantially equal to transmission frequency band ΔBᵢ. Such an application enables to generate a high-power millimeter wave carried by central waveguide 52 based on low-power millimeter waves transmitted by each antenna 42ᵢ, i varying from 1 to N.

According to an embodiment, the propagation mode of electromagnetic waves in waveguide 50 is different from the transverse electromagnetic mode, also known as TEM mode.

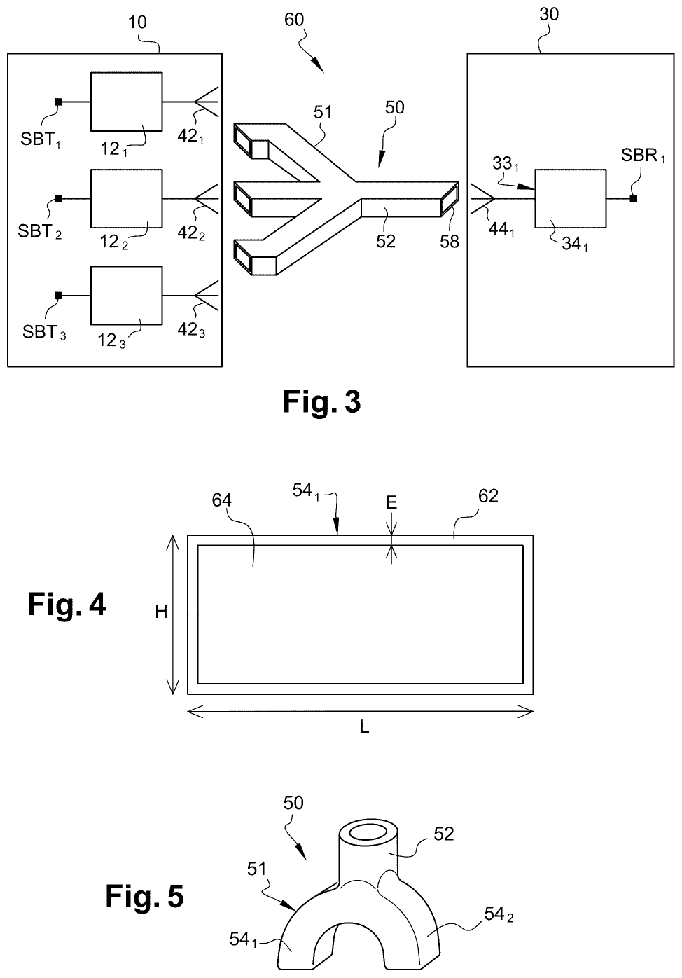

FIG. 3 is a diagram showing a millimeter wave transmission system 60. Millimeter wave transmission system 60 comprises all the elements of the millimeter wave transmission system 40 shown in FIG. 2, with the difference that reception device 30 comprises a single reception block 33₁, and that waveguide 50 does not comprise distribution part 53, central guide 52 comprising an end 58 located opposite the antenna 44₁ of reception block 33₁. This embodiment may in particular be implemented in the case where transmission frequency bands ΔBᵢ are substantially identical to transmission frequency band ΔB.

FIG. 4 is a cross-section view of an embodiment of the branch 54₁ of the waveguide 50 of the millimeter wave transmission system 40 of FIG. 2. Branch 54₁ comprises a tube 62 made of a dielectric plastic material delimiting an inner volume 64. Inner volume 64 may be filled with a gas or with a gas mixture, for example air, or with a liquid or solid dielectric material having a dielectric constant that may be lower than that of the dielectric material forming tube 62. Preferably, inner volume 64 is filled with air. According to an embodiment, tube 62 is surrounded by a sheath, not shown in FIG. 4, made of a dielectric material having a dielectric constant lower than that of the dielectric material forming tube 62. According to another embodiment, branch 54₁ comprises a solid rod of dielectric plastic material.

According to an embodiment, tube 62 or the solid rod has a substantially rectangular or circular cross-section, other shapes of cross-sections being however possible (for example, an elliptical cross-section). Preferably, tube 62 or the solid rod has a substantially rectangular cross-section, which favors the propagation of millimeter waves in the TE10 mode. In the embodiment illustrated in FIG. 4, tube 62 or the rod has a substantially rectangular cross-section having a width L and a height H. According to an embodiment, width L is in the range from 0.5 mm to 10 mm. According to an embodiment, height H is in the range from 0.25 mm to 5 mm. According to an embodiment, the thickness E of the wall of tube 62 is in the range from 0.5 mm to 10 mm.

The dielectric constant of the dielectric material forming the tube 62 or the rod of branch 54₁ is, for example, in the range from 1 to 4, preferably from 2 to 4. The loss angle or tangent delta of the dielectric material forming the tube 62 or the rod of branch 54₁ is, for example, lower than 10⁻³ to ensure minimum losses of the signal in branch 54₁. This material may be a dielectric plastic material such as polytetrafluoroethylene, polypropylene, or polystyrene. As an example, for a material having a dielectric constant equal to 2 and a frequency in the range from 30 GHz to 300 GHz, the wavelength of the electromagnetic waves propagating in branch 54₁ is in the range from 7 mm to 0.7 mm. Waves at a frequency in the order of 60 GHz may for example be used, for which, for a material having a dielectric constant equal to 2, the wavelength is equal to 3.5 mm.

Each branch 54₂ to 54_{N} may have the same characteristics as those described hereabove for branch 54₁. Each branch 56₁ to 56_{M} may have the same characteristics as those described hereabove for branch 54₁. Central waveguide 52 may have the same characteristics as those described hereabove for branch 54₁.

According to an embodiment, the dimensions of the cross-sections of branches 54₁ to 54_{N} are different. In particular, the dimensions of the cross-section of branch 54; are adapted to the frequency band ΔBᵢ of the millimeter waves conveyed by branch 54ⱼ. According to another embodiment, the dimensions of the cross-sections of branches 54₁ to 54_{N} are identical. According to an embodiment, the dimensions of the cross-sections of branches 56₁ to 56_{M} are different. In particular, the dimensions of the cross-sections of branch 56ⱼ are adapted to the frequency band of the millimeter waves to be processed by the reception block 33j associated with branch 56ⱼ. According to another embodiment, the dimensions of the cross-sections of branches 56₁ to 56_{M} are identical.

According to an embodiment, the shape (for example, circular shape, rectangular shape, etc.) of the cross-section of central waveguide 52 is different from the shape of the cross-section of branches 54₁ to 54_{N}.

FIG. 5 is a perspective view, partial and simplified, of an embodiment of a waveguide 50 having its collection part 51 comprising two branches 54₁ and 54₂, although the number of branches 54ᵢ may be greater than 2, each having a rectangular cross-section, and its central waveguide 52 having a circular cross-section.

This may be advantageous in that waveguide 52 may have a length greater than the length of each branch 54₁ and 54₂, and the manufacturing on an industrial scale of a waveguide having a circular cross-section is simpler than the manufacturing of a waveguide of rectangular cross-section. Each branch 54₁, 54₂ having a rectangular cross-section which receives a millimeter wave supplied by the associated antenna 42₁, 42₂ enables to decrease losses during the capture by branch 54₁, 54₂ of the millimeter wave transmitted by the associated antenna 42₁, 42₂.

This may further allow the transmission over central waveguide 52a of circular cross-section of a first millimeter wave originating from branch 54₁ and of a second millimeter wave originating from branch 54₂, the first and second millimeter waves being orthogonally polarized, and frequency bands ΔB₁ and ΔB₂ being possibly identical. This advantageously enables to double the data transmission rate over frequency band ΔB₁.

Waveguide 50 may be a monoblock part, or it may be obtained by assembly of a plurality of parts.

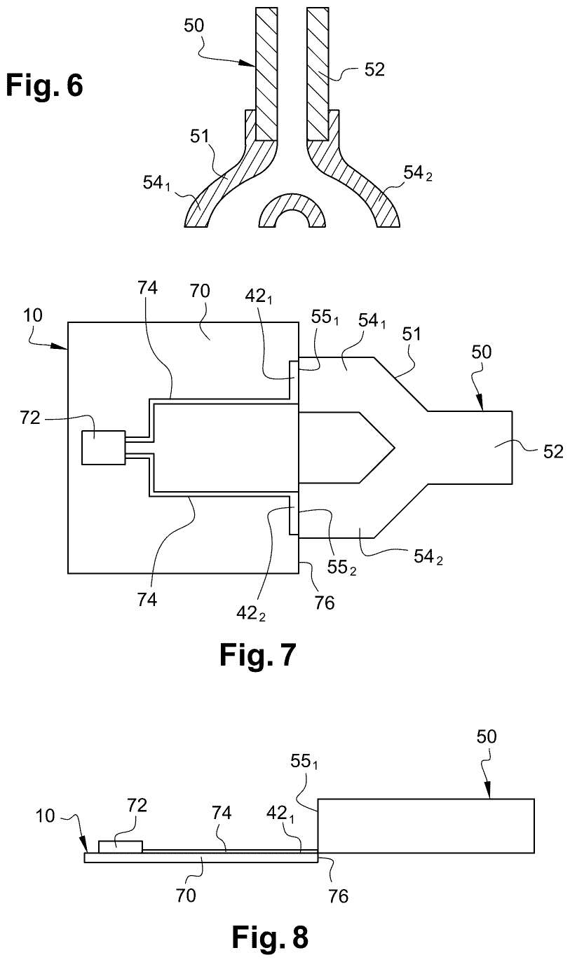

FIG. 6 is a perspective view, partial and simplified, of waveguide 50, having its collection part 51 comprising two branches 54₁ and 54₂, although the number of branches 54; may be greater than 2, and which corresponds to a part separate from central waveguide 52. The methods of manufacturing central waveguide 52 and collection part 51 may then be different. As an example, central waveguide 52 may be manufactured by extrusion, and collection part 51 may be manufactured by molding.

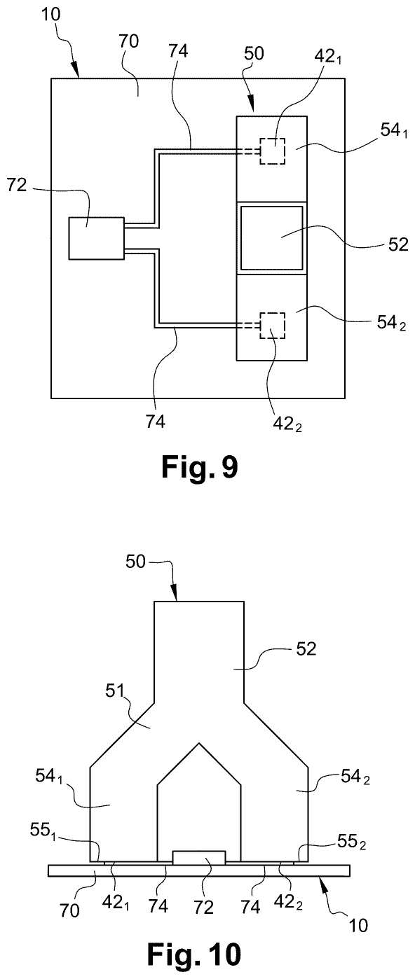

FIG. 7 and FIG. 8 respectively are a top view and a side view, partial and simplified, illustrating the connection between waveguide 50 and transmission device 10 according to an embodiment. FIG. 9 and FIG. 10 are drawings respectively similar to FIG. 7 and to FIG. 8, illustrating the connection between waveguide 50 and transmission device 10 according to another embodiment.

In FIGS. 7 to 10, the collection part 51 of waveguide 50 comprises two branches 54₁ and 54₂, although the number of branches 54; may be greater than 2. In FIGS. 7 to 10, transmission device 10 comprises, as an example, a printed circuit 70 and at least one microprocessor 72 assembled on printed circuit 70. Antennas 42₁ and 42₂ are formed by conductive tracks 74 of printed circuit board 70, antennas 42₁ and 42₂ being shown in dotted lines in FIG. 9.

In FIGS. 7 and 8, waveguide 50 is assembled according to a so-called edge coupling. Antennas 42₁ and 42₂ are formed along an edge 76 of printed circuit 70, and the branches 54₁ and 54₂ of waveguide 50 are arranged along edge 76 in such a way that the axis of each branch 54₁, 54₂ at end 55₁, 55₂ is substantially parallel to the plane of printed circuit 70. Each antenna 42₁, 42₂ may be in contact with the end 55₁, 55₂ of the corresponding branch 54₁, 54₂.

In FIGS. 9 and 10, waveguide 50 is assembled according to a so-called vertical coupling. The branches 54₁ and 54₂ of waveguide 50 are arranged so that the axis of each branch 54₁, 54₂ at end 55₁, 55₂ is substantially perpendicular to the plane of printed circuit 70. Each antenna 42₁, 42₂ may be covered by the corresponding branch 54₁, 54₂.

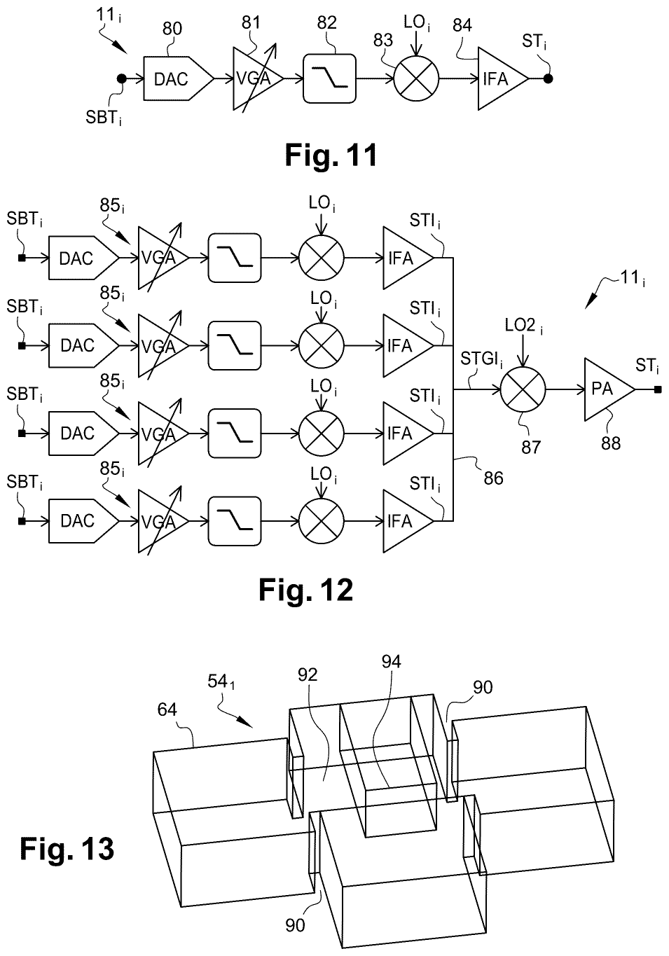

FIG. 11 is a block diagram of an embodiment of a transmission block 11ᵢ, i varying from 1 to N, in which transmission block 11; receives a single digital signal SBTᵢ, and performs a modulation to deliver signal SMT in transmission frequency band ΔBᵢ.

Transmission block 11; comprises:
a digital-to-analog converter 80 (DAC) receiving signal SBTᵢ and delivering an analog signal in a base frequency band;
an adjustable-gain amplifier 81 (VGA) receiving the analog signal delivered by digital/analog converter 80 and delivering an amplified analog signal;
a filter 82 receiving the amplified analog signal delivered by adjustable-gain amplifier 81 and delivering a filtered signal;
a mixer 83 receiving the filtered signal delivered by filter 82 and further receiving an oscillating signal LOᵢ and delivering a signal in the transmission frequency band ΔBᵢ corresponding to the filtered signal delivered by filter 82 mixed with oscillating signal LOᵢ;
an amplifier 84 (IFA) receiving the signal delivered by mixer 83 and delivering signal STᵢ, which corresponds to the signal delivered by mixer 83, which is amplified.

FIG. 12 is a block diagram of another embodiment of a transmission block 11ᵢ, i varying from 1 to N. In this embodiment, transmission block 11ᵢ receives a plurality of digital signals SBTᵢ and performs a first modulation to deliver an analog signal STIᵢ in an intermediate frequency band. Transmission block 11ᵢ then delivers an analog signal STGIᵢ equal to the sum of the analog signals STIᵢ and then performs a second modulation from signal STGᵢ to deliver signal STᵢ in transmission frequency band ΔBᵢ.

According to an embodiment, transmission block 11ᵢ comprises:
for each received digital signal SBTᵢ, a sub-block 85ᵢ which comprises all the elements previously described in relation with FIG. 11 and which delivers analog signal STIᵢ in an intermediate frequency band;
a combination circuit 86 receiving the signals STIᵢ delivered by sub-blocks 85ᵢ and delivering the global signal STG; substantially corresponding to the sum of signals STᵢ;
a mixer 87 receiving global signal STG; and further receiving an oscillating signal LO2ᵢ and delivering a signal in transmission frequency band ΔBᵢ, corresponding to the global signal STGᵢ mixed by oscillating signal LO2ᵢ; and
an amplifier 88 (PA) receiving the signal delivered by mixer 87 and delivering signal STᵢ, which corresponds to the signal delivered by mixer 87 which is amplified.

For certain applications, it may be desirable to filter signal STᵢ, i varying from 1 to N, and/or to filter signal SRⱼ, j varying from 1 to M. According to an embodiment, this is achieved by adding, for each transmission block 11ᵢ, a filter receiving signal STᵢ and delivering a filtered signal to antenna 42ᵢ and/or by adding, for each reception block 33ⱼ, a filter receiving signal SRⱼ from antenna 44ⱼ and delivering a filtered signal to reception block 33ⱼ.

According to another embodiment, this filtering function is performed directly by waveguide 50. According to an embodiment, the filtering function may be implemented on each branch 54ᵢ, on central waveguide 52, and/or on each branch 56ⱼ. According to an embodiment, the filtering function is implemented by providing branch 54ᵢ, central waveguide 52, and/or branch 56ⱼ with a cross-section that varies along branch 54ᵢ, central waveguide 52, and/or branch 56ⱼ.

FIG. 13 is a perspective view, partial and simplified, of the inner volume 64 of branch 54₁ illustrating the implementation of a filtering function by branch 54₁. As an example, the cross-section of branch 54₁ comprises abrupt variations, for example one or a plurality of bottlenecks 90 in which the cross-section of branch 54₁ is decreased, one or a plurality of expansion zones 92 in which the cross-section of branch 54₁ is increased, and/or one or a plurality of obstacles 94 on the path of the millimeter waves.

Various embodiments and variants have been described. Those skilled in the art will understand that certain features of these various embodiments and variants could be combined, and other variants will become apparent to those skilled in the art. The system 40 of FIG. 2 may be used in full-duplex mode, transmission device 10 then further comprising a millimeter wave reception device, for example similar to reception device 30, and reception device 30 further comprising a millimeter wave transmitting device, for example similar to reception device 10, so that millimeter waves can be conveyed by waveguide 50 in both directions.

Finally, the practical implementation of the described embodiments and variants is within the abilities of those skilled in the art, based on the functional indications given hereabove.

1. Millimeter waveguide comprising a first part coupled to a second part, the first part comprising first waveguides, each being configured to receive a first millimeter wave, and the second part corresponding to a second waveguide, each first waveguide comprising a first free end and a second end joined with the second waveguide, each first and second waveguide being entirely made of a dielectric material.

2. Millimeter waveguide according to claim 1, further comprising a third part comprising third waveguides, each third waveguide comprising a first free end and a second end joined with the second waveguide.

3. Millimeter waveguide according to claim 1, wherein the first and second waveguides each comprise a tube delimiting an inner volume filled with a gas, with a gas mixture, with a fluid, or with a solid having a dielectric constant lower than that of the dielectric material.

4. Millimeter waveguide according to claim 3, wherein the dimensions of the cross-sections of the first waveguides are different.

5. Millimeter waveguide according to claim 3, wherein the cross-section of the tube of at least one of the first waveguides is rectangular and wherein the cross-section of the tube of the second waveguide is circular.

6. Millimeter waveguide according to claim 1, wherein the first and second waveguides are each made of a plastic material, in particular polytetrafluoroethylene, polypropylene, or polystyrene.

7. System for transmitting first millimeter waves, comprising a millimeter waveguide according to claim 1, a millimeter wave transmission device and a millimeter wave reception device, the millimeter wave transmission device comprising, for each first waveguide, an antenna configured for the transmission of millimeter waves and coupled to said first waveguide.

8. System according to claim 7, wherein each first millimeter wave has a frequency band between 30 GHz and 300 GHz.

9. System according to claim 8, wherein the frequency bands of the first millimeter waves are distinct.
